(19) United States
(12) Patent Application Publication
(10) Pub. No.: US 2025/0239236 A1
(43) Pub. Date: Jul. 24, 2025

(54) INFORMATION PROCESSING APPARATUS FOR CONTROLLING IMAGE DISPLAY, INFORMATION PROCESSING SYSTEM, STORAGE MEDIUM STORING INFORMATION PROCESSING PROGRAM, AND INFORMATION PROCESSING METHOD

(71) Applicant: CANON KABUSHIKI KAISHA, Tokyo (JP)

(72) Inventor: YUMA KITASEI, Kanagawa (JP)

(21) Appl. No.: 19/030,255

(22) Filed: Jan. 17, 2025

(30) Foreign Application Priority Data
Jan. 24, 2024 (JP) 2024-009058

(51) Int. Cl. G09G 5/377; G06T 19/00

(52) U.S. Cl. CPC G09G 5/377; G06T 19/006

(57) ABSTRACT

An information processing apparatus, includes a processor, and a memory storing a program which, when executed by the processor, causes the information processing apparatus to perform image acquisition processing for acquiring a captured image, and perform display control processing for displaying, on a display, a composite image obtained by the captured image and a virtual screen being composited, wherein, in the display control processing, control is performed so that in a case where a mobile terminal is in a portrait state when viewed from a user, the virtual screen is displayed in the portrait state on the display, and that in a case where the mobile terminal is in a landscape state when viewed from the user, the virtual screen is displayed in the landscape state on the display.

### BACKGROUND OF THE DISCLOSURE

### Field of the Disclosure

The present disclosure relates to an information processing apparatus for controlling image display.

### Description of the Related Art

There has been a technique for connecting a Head Mounted Display (HMD) and a mobile terminal such as a smartphone or tablet terminal, and displaying the screen of the mobile terminal on the HMD.

The Publication of Japanese Patent No. 6940702 discusses a method for selecting whether to display the screen of a mobile terminal such as a smartphone or a tablet terminal on an HMD according to the state of the mobile terminal.

However, the Publication of Japanese Patent No. 6940702, is silent about a method for determining the orientation of the screen to be displayed on the HMD according to the state of the mobile terminal. Therefore, the method has not necessarily been usable.

### SUMMARY OF THE DISCLOSURE

The present disclosure is directed to providing an information processing apparatus that provides improved usability when an HMD and a mobile terminal are used in combination.

According to an aspect of the present disclosure, an information processing apparatus, includes a processor, and a memory storing a program which, when executed by the processor, causes the information processing apparatus to perform image acquisition processing for acquiring a captured image, and perform display control processing for displaying, on a display, a composite image obtained by the captured image and a virtual screen being composited, wherein, in the display control processing, control is performed so that in a case where a mobile terminal is in a portrait state when viewed from a user, the virtual screen is displayed in the portrait state on the display, and that in a case where the mobile terminal is in a landscape state when viewed from the user, the virtual screen is displayed in the landscape state on the display.

Further features of the present disclosure will become apparent from the following description of exemplary embodiments with reference to the attached drawings.

### BRIEF DESCRIPTION OF THE DRAWINGS

FIG. 1 is a block diagram illustrating a display apparatus and a mobile terminal according to one or more aspects of the present disclosure.

FIG. 2 is a connection block diagram illustrating the display apparatus and the mobile terminal according to one or more aspects of the present disclosure.

FIG. 3 illustrates the display apparatus at a predetermined point in time, and a coordinate system according to an orientation of the display apparatus at a predetermined point in time according to one or more aspects of the present disclosure.

FIG. 4 illustrates the mobile terminal in a portrait state according to one or more aspects of the present disclosure.

FIG. 5 illustrates the mobile terminal in a landscape state according to one or more aspects of the present disclosure.

FIG. 6 illustrates the mobile terminal in a flat state according to one or more aspects of the present disclosure.

FIG. 7 is a sequence diagram illustrating the display apparatus and the mobile terminal according to one or more aspects of the present disclosure.

FIG. 8 is a flowchart illustrating processing of the display apparatus according to one or more aspects of the present disclosure.

FIG. 9 is a flowchart illustrating processing of the mobile terminal according to one or more aspects of the present disclosure.

FIG. 10 is a sequence diagram illustrating the display apparatus and the mobile terminal according to one or more aspects of the present disclosure.

FIG. 11A illustrates an example of a scene image which is visually recognized by a user according to one or more aspects of the present disclosure, where the mobile terminal is horizontally placed to the ground in a landscape state. FIG. 11B illustrates another example of a scene image which is visually recognized by the user according to one or more aspects of the present disclosure, where the mobile terminal is laterally rested against an object. FIG. 11C illustrates still another example of a scene image which is visually recognized by the user according to one or more aspects of the present disclosure, where the mobile terminal is longitudinally rested against the object.

FIG. 12 illustrates an example of an image which is visually recognized by the user according to one or more aspects of the present disclosure.

### DESCRIPTION OF THE EMBODIMENTS

Exemplary embodiments will be described below with reference to the accompanying drawings. The following exemplary embodiments do not limit the present disclosure within the scope of the appended claims. Although a plurality of features is described in the exemplary embodiments, not all of the plurality of features is indispensable to the present disclosure, and the plurality of features may be combined in any manner. In the accompanying drawings, identical or similar components are assigned the same reference numerals, and duplicated descriptions thereof will be omitted.

A first exemplary embodiment will be described below on the assumption that a Head Mounted Display (HMD) and a mobile terminal are connected and that an application (also referred to as an application) displays the screen of the mobile terminal on the HMD. Examples of such applications include a remote desktop application and a mirroring application to be downloaded into the HMD.

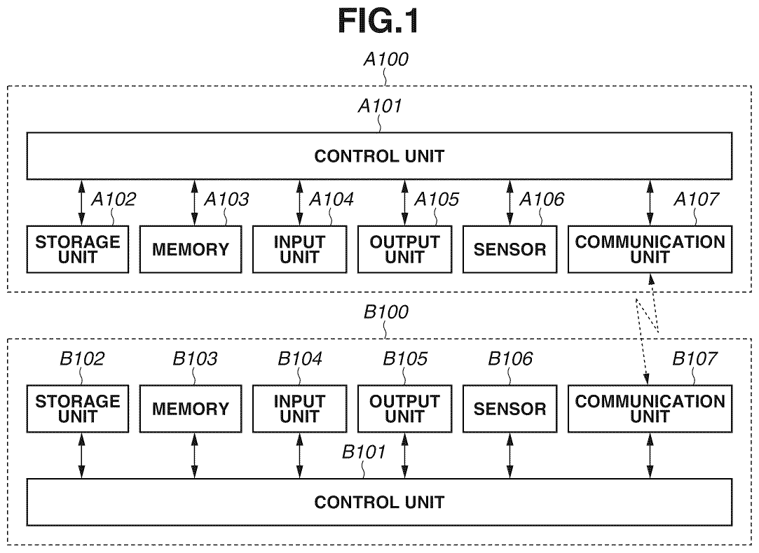

The configuration of the present disclosure will be described below with reference to FIG. 1.

FIG. 1 is a block diagram illustrating a display apparatus and a mobile terminal according to the present exemplary embodiment. In the present exemplary embodiment, a description will be provided on the assumption that an HMD is used as a display apparatus A100 and a terminal such as a smartphones is used as a mobile terminal B100.

### Internal Configuration of HMD

The display apparatus A100 includes a control unit A101, a storage unit A102, a memory A103, an input unit A104, an output unit A105, a sensor A106, and a communication unit A107.

Although an HMD will be described below as an example of an information processing apparatus, the information processing apparatus is not limited thereto. For example, part of processing of the information processing apparatus may be executed by a smartphone, tablet terminal, or personal computer (PC), and each unit of the display apparatus A100 may be included in a smartphone, a tablet terminal, and a PC. Part of the processing may be performed by the mobile terminal B100 (described below) or an apparatus that is different from the mobile terminal B100.

The control unit A101 is a central processing unit (CPU) for controlling each unit of the display apparatus A100. In response to obtaining a composite image (an image as a combination of an image of the space in front of the user captured by the imaging unit 202 and a computer graphics [CG]), the control unit A101 functions as a display control unit configured to display the composite image. Instead of the control unit A101 controlling the entire display apparatus A100, the entire display apparatus A100 may be controlled by a plurality of hardware components that share processing. The control unit A101 may generate a composite image or acquire a composite image generated by a PC wired or wirelessly connected. The user can recognize a mixed reality space by visually recognizing such a composite image.

For example, the storage unit A102 is an electrically erasable and recordable nonvolatile storage medium, such as a solid state drive (SSD) and a flash memory, for storing programs to be executed by the control unit A101, databases, user settings, and other types of information.

A memory A103, for example a Random Access Memory (RAM), is used as a buffer memory for temporarily storing various data and a work area of the control unit A101.

The input unit A104 is used to input an instruction for the display apparatus A100. The input unit A104 includes a power button for issuing an instruction to turn power of the display apparatus A100 ON and OFF, and operation buttons for issuing screen transition instructions. The input unit A104 does not necessarily include the display apparatus A100. Instructions may be input via the communication unit A107 (described below).

The output unit A105 displays, for example, a graphical user interface (GUI) for interactive operations. The output unit A105 is a light emitting apparatus such as a light emitting diode (LED), a voice output apparatus such as a speaker, and a display unit such as a display. The output unit A105 may be configured to output data via the communication unit A107 (described below).

The sensor A106 is, for example, an image sensor for capturing the surrounding image, and a sensor such as a light detection and ranging (LiDAR) sensor and a Time of Flight (ToF) sensor for measuring the surrounding status. The sensor A106 includes a sensor such as an Inertial Measurement Unit (IMU) for orientation and position measurement and a geomagnetism sensor. The image sensor is an image acquisition unit for acquiring a captured image.

The communication unit A107 is, for example, a universal serial bus (USB) for connection to other apparatus and an Ethernet connector (RJ45), for wired communication. The communication unit A107 may include a communication unit for wirelessly communicating with a controller and an external apparatus, such as a Network Interface Card (NIC) with a built-in communication integrated circuit (IC). The communication unit A107 may perform wireless communication with Wireless Fidelity (Wi-Fi®) and Bluetooth®.

### Internal Configuration of Smartphone

The mobile terminal B100 includes a control unit B101, a storage unit B102, a memory B103, an input unit B104, an output unit B105, a sensor B106, and a communication unit B107.

The control unit B101, the storage unit B102, the memory B103, and the input unit B104 of the mobile terminal B100 have the same configurations as those of the control unit A101, the storage unit A102, the memory A103, and the input unit A104 of the display apparatus A100, respectively, and redundant descriptions thereof will be omitted. The output unit B105, the sensor B106, and the communication unit B107 of the mobile terminal B100 have the same configurations as those of the output unit A105, the sensor A106, and the communication unit A107 of the display apparatus A100, respectively, and redundant descriptions thereof will be omitted.

The terminal configuration has been described above on the assumption that an HMD is used as the display apparatus A100 and a smartphone is used as the mobile terminal B100, the terminal configuration is merely one example. The display apparatus A100 is not limited to an HMD but may be a hand-held device, smart glass, goggle type display, or wearable device such as a smart contact lens, and different terminal configurations may also be applicable. The mobile terminal B100 is not limited to a smartphone but may be a tablet terminal or PC, and different mobile terminal configurations may also be applicable. The mobile terminal B100 may also be a smart watch.

### Connection Configuration Between Apparatuses

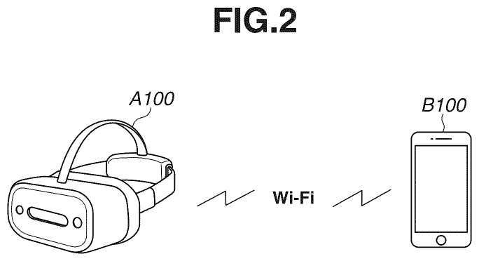

An information processing system according to the first exemplary embodiment of the present disclosure will be described below with reference to FIG. 2. The information processing system in FIG. 2 includes the display apparatus A100 and the mobile terminal B100.

As illustrated in FIG. 2, the system according to the present exemplary embodiment includes the display apparatus A100 and the mobile terminal B100. The following description will be provided based on the premise that the display apparatus A100 and the mobile terminal B100 have hardware configurations similar to those of the display apparatus A100 and the mobile terminal B100 illustrated in FIG. 1.

The display apparatus A100 includes a Wi-Fi communication unit serving as the communication unit A107 and can be connected to a local network via a router.

Similarly, the mobile terminal B100 also includes a Wi-Fi communication unit as the communication unit B107 and can be connected to a local network via a router.

The display apparatus A100 and the mobile terminal B100 can communicate with each other via a local network and bi-directionally communicate all types of data.

The above-described connection configuration is merely an example, and the different connection methods and configurations may also be applicable.

### HMD Orientation Acquisition Method

A method for acquiring the orientation information for the display apparatus A100 according to the present exemplary embodiment will be described below.

There are various methods for acquiring the orientation information for the display apparatus A100. For example, a camera and an accelerometer mounted on the display apparatus A100 may be utilized to calculate orientation information through self-localization techniques such as Simultaneous Localization and Mapping (SLAM), thus obtaining the orientation information. Additionally, a plurality of external sensors may be provided to measure and acquire the information and using position tracking technology.

The above-described methods for acquiring the orientation information for the display apparatus A100 are merely examples, and different methods for acquiring the orientation information for the display apparatus A100 may also be applicable.

### Mobile Terminal Orientation Acquisition Method

A method for acquiring the orientation information about the mobile terminal B100 from display apparatus A100 according to the present exemplary embodiment will be described below.

There are various methods for acquiring the orientation information about the mobile terminal B100 from the display apparatus A100. For example, image recognition is performed using the camera mounted on the display apparatus A100 and orientation information about the mobile terminal B100 may be calculated and obtained. Additionally, the orientation information calculated through self-localization techniques such as SLAM by using a camera or an acceleration sensor mounted on the mobile terminal B100 may be acquired from the mobile terminal B100. In addition, the orientation information about the mobile terminal B100 is calculated through distance measurement techniques by using a wireless communication unit such as Bluetooth® or Ultra-Wide Band (UWB) mounted on the display apparatus A100 and the mobile terminal B100 to acquire the orientation information.

Any methods are applicable for methods for acquiring the orientation information about the mobile terminal B100 from the display apparatus A100, as long as the method is suitable for the configurations of the display apparatus A100 and the mobile terminal B100 and a combination of both.

The foregoing methods for acquiring the orientation information about the mobile terminal B100 from the display apparatus A100 are merely examples, and different methods for acquiring the orientation information about the mobile terminal B100 from the display apparatus A100 may also be applicable.

### Coordinate System of Display Apparatus

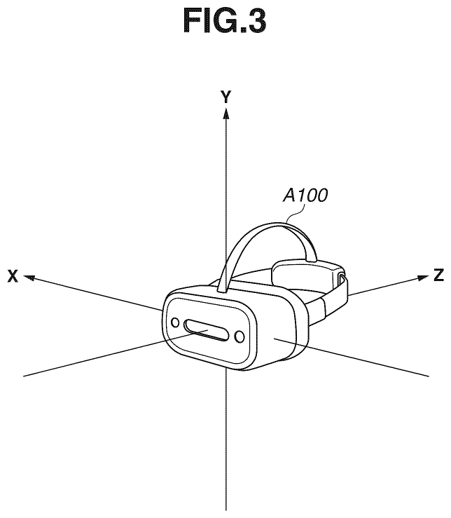

The coordinate system based on the orientation of the display apparatus A100 at a predetermined point in time according to the present exemplary embodiment will be described below with reference to FIG. 3.

In the present exemplary embodiment, the coordinate system is determined based on the orientation of the display apparatus A100 at a predetermined point in time.

The orientation of the image to be displayed on the display apparatus A100 is determined based on the determined coordinate system and the orientation of the mobile terminal B100. Examples of the orientation of the display apparatus A100 at a predetermined point in time include the orientation of the display apparatus A100 immediately after activation of an application of the display apparatus A100, and the orientation of the display apparatus A100 when a display reset operation is performed with a button mounted on the display apparatus A100. More specifically, the orientation of the display apparatus A100 refers to the orientation information about the display apparatus A100 that serves as a reference for determining the display orientation of the image to be displayed on the display apparatus A100. The basis for determining the coordinates is not limited to the orientation of the display apparatus A100. The coordinates may be determined based on a real object such as a predetermined apparatus or a marker.

According to the present exemplary embodiment, the direction from the front face to the rear face of the display apparatus A100 when the user wears the display apparatus A100 is the Z axis, with reference to the orientation of the display apparatus A100 at this predetermined point in time. The direction perpendicular to the Z axis, from the legs to the head of the user is the Y axis. The following description will be provided based on the premise that the direction perpendicular to the Y and Z axes, from the left to the right of the user is the X axis. FIG. 3 illustrates the display apparatus A100 at a predetermined point in time, and the coordinate system based on the orientation of the display apparatus A100 at a predetermined point in time, according to the present exemplary embodiment. Referring to FIG. 3, the front direction of the display apparatus A100 corresponds to the negative direction of the Z axis, and the rear direction of the display apparatus A100 corresponds to the positive direction of the Z axis.

The above-described coordinate system based on the orientation of the display apparatus A100 at a predetermined point in time is defined for description of the present exemplary embodiment. Thus, the coordinate system based on the orientation of the display apparatus A100 at a predetermined point in time does not need to be defined, and different coordinate systems may also be applicable.

The coordinate system at a predetermined point in time may be defined each time a captured image is acquired (for each frame) or defined each timer the orientation of the display apparatus A100 is acquired.

The coordinate system at a predetermined point in time may be updated at regular intervals or updated if the orientation of the display apparatus A100 changes from the orientation at the time of determination of the coordinate system to an extent that exceeds a threshold value.

### Determining Mobile Terminal Orientation

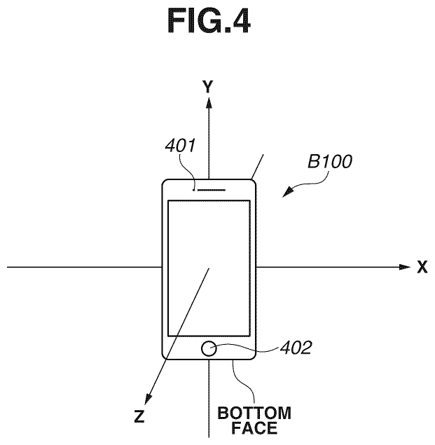

A description will be provided of a method for determining the orientation of the mobile terminal B100 according to the present exemplary embodiment, specifically, longitudinally oriented (portrait orientation), laterally oriented (landscape orientation), or in a flat state, with reference to FIGS. 4, 5, and 6.

To determine which of the portrait, landscape, and flat states the orientation of the mobile terminal B100 is in, the coordinate system based on the orientation of the display apparatus A100 at a predetermined point in time and the orientation information about the mobile terminal B100 are used. Assuming a smartphone as the mobile terminal B100, the screen side is defined as the front face, and the side opposite to the screen side is defined as the rear face. If a camera 401 is provided on the front face as in the mobile terminal B100 in FIG. 4, when the mobile terminal B100 is viewed so that the camera 401 on the front face is positioned above the screen, the side face on the upper side is defined as the top face, the side face on the lower side is defined as the bottom face, the side face on the right side is defined as the right side face, and the side face on the left side is defined as the left side face. If a button 402 is provided on the front face as in the mobile terminal B100 in FIG. 4, when the mobile terminal B100 is viewed so that the button 402 is positioned below the screen, the side face on the upper side is defined as the top face, the side face on the lower side is defined as the bottom face, the side face on the right side is defined as the right side face, and the side face on the left side is defined as the left side face.

The method for acquiring the coordinate system based on the orientation of the display apparatus A100 at a predetermined point in time, and the method for acquiring the orientation information about the mobile terminal B100 from the display apparatus A100 are as described above.

If the bottom face of the mobile terminal B100 is perpendicular to the Y axis, as illustrated in FIG. 4, the mobile terminal B100 is determined to be in a portrait state.

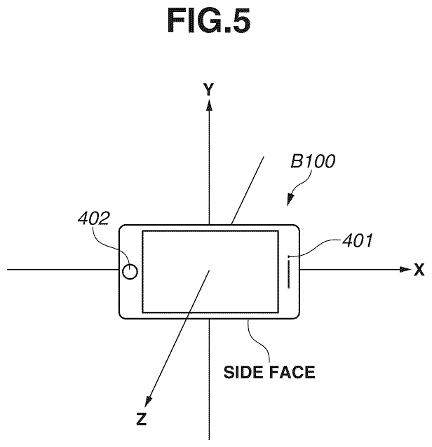

If the side faces of the mobile terminal B100 are perpendicular to the Y axis, as illustrated in FIG. 5, the mobile terminal B100 is determined to be in a landscape state.

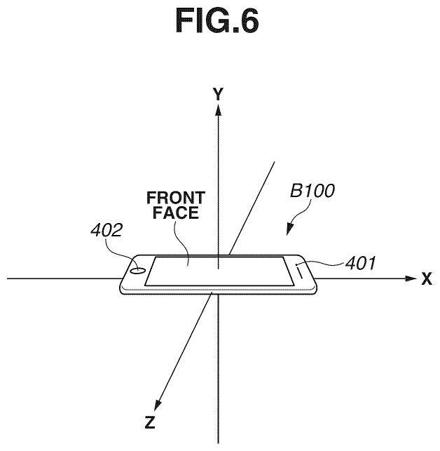

If the front face of the mobile terminal B100 is perpendicular to the Y axis, as illustrated in FIG. 6, the mobile terminal B100 is determined to be in a flat state.

However, the mobile terminal B100 is rarely in a perpendicular position to the axes as described above. In such a case, which of the above-described states (portrait, landscape, and flat states) the mobile terminal B100 is closest to is determined.

For example, turning counterclockwise the mobile terminal B100 in the portrait state as illustrated in FIG. 4 by 90 degrees about the Z axis changes the orientation of the mobile terminal B100 to the landscape state as illustrated in FIG. 5. At this point, the midpoint angle is 45 degrees. Thus, using 45 degrees as a reference, if the angle is within the range of 0 to 45 degrees, the mobile terminal B100 is determined to be in the portrait state; if the angle is within the range of 45 to 90 degrees, the mobile terminal B 100 is determined to be in the landscape state. Similarly, by using 45 degrees as a reference for the X-axis and Y-axis, the orientation of the mobile terminal B100, whether in portrait, landscape, or flat states, is determined.

In a case where only one threshold value is used as described above, if the orientation of the mobile terminal B100 is close to the threshold value, the orientation of the mobile terminal B100 frequently changes between the portrait, landscape, and flat states a number of times in a short period of time. Therefore, two different threshold values may be set. For example, by using different threshold values between a case where the state of the mobile terminal B100 changes from a portrait to a landscape state and a case where the state changes vice versa, the phenomenon where the state frequently changes in a short period of time can be prevented.

The above-described method for determining which of the portrait, landscape, and flat states the orientation of the mobile terminal B100 is in is merely an example, and different methods for determining which of the portrait, landscape, and flat states the orientation of the mobile terminal B100 is in may also be applicable.

The orientation of the mobile terminal B100 may be different from those three states: the portrait, landscape, and flat states. For example, even if the mobile terminal B100 is in a portrait state, meaning may be different between a state where the top face is upwardly oriented and a state where the top face is downwardly oriented. In this case, the number of states exceeds three.

Depending on a system to be configured, the number of states may be less than three. Thus, an appropriate number of states of the mobile terminal B100 is to be defined according to the system to be configured.

In the present exemplary embodiment, the states of the mobile terminal B100 is defined by using the coordinate system based on the orientation of the display apparatus A100 at a predetermined point in time. However, the state of the mobile terminal B100 may be defined according to the orientation of the mobile terminal B100 with respect to the gravity direction, whether the orientation of the mobile terminal B100 is horizontal to the ground, or which surface is the bottom face (the surface closest to the ground). For example, if the bottom face is perpendicular to the gravity direction or positioned below the screen, the mobile terminal B100 is defined to be in a portrait state. If the right or the left side face is perpendicular to the gravity direction or positioned below the screen, the mobile terminal B100 is defined to be in a landscape state. If the front and rear faces are perpendicular to the gravity direction or positioned below the screen, the mobile terminal B100 is defined to be in a flat state.

Additionally, the orientation of the smartphone, whether in portrait, landscape, or flat state, may be defined based on the position of its components, such as the camera or buttons, in relation to which direction they are perpendicular or parallel to, as well as their location with respect to specific surfaces.

### Method for Determining Image Display Orientation

A method for determining the image display orientation according to the present exemplary embodiment will be described below.

As described above, the display orientation of the image to be displayed on the display apparatus A100 is determined based on the orientation of the display apparatus A100 at a predetermined point in time, the coordinate system based on the orientation, and the orientation of the mobile terminal B100.

If the mobile terminal B100 is in the portrait state, the image display orientation is determined so that the mobile terminal B100 faces front with respect to the orientation of the display apparatus A100 at a predetermined point in time in the portrait state.

If the mobile terminal B100 is in a landscape state, the image display orientation is determined so that the mobile terminal B100 faces front with respect to the orientation of the display apparatus A100 at a predetermined point in time in a landscape state.

If the mobile terminal B100 is in a flat state, whether the bottom face of the mobile terminal B100 is horizontal or vertical is determined. If the bottom face of the mobile terminal B100 is closer to the horizontal direction than to the vertical direction, the image display orientation is determined so that the mobile terminal B100 faces front with respect to the orientation of the display apparatus A100 at a predetermined point in time in a portrait state. If the bottom face of the mobile terminal B100 is closer to the vertical direction than to the horizontal direction, the image display orientation is determined so that the mobile terminal B100 faces front with respect to the orientation of the display apparatus A100 at a predetermined point in time in a landscape state.

In the present exemplary embodiment, the image display orientation is determined so that the mobile terminal B100 faces front with respect to the orientation of the display apparatus A100 at a predetermined point in time. However, a method for determining the image display orientation so that the mobile terminal B100 faces front with respect to the current orientation of the display apparatus A100 may also be applicable.

The above-described method for determining the image display orientation is merely an example, and different methods for determining the image display orientation may also be applicable.

### Method for Determining Display Position of Virtual Screen

A method for determining the display position of the virtual screen according to the present exemplary embodiment will be described below.

In the present exemplary embodiment, positional information is acquired from the orientation information about the mobile terminal B100 and the display position of the virtual screen to be displayed on the display apparatus A100 is determined so that the image virtual screen is displayed above the mobile terminal B100. The method for determining the display position of the virtual screen is merely an example, and different methods for determining the display position of the virtual screen may also be applicable. For example, the virtual screen may be displayed at a position preset by the user. More specifically, the virtual screen may be displayed so that the virtual screen follows the movement of the user (the movement of the display apparatus A100). In this case, the virtual screen seems to follow the movement of the user. However, in generating a composite image, the virtual screen is composited so that the virtual screen is displayed at the same position irrespective of the background image. The virtual screen may be displayed at a predetermined position in front of the user irrespective of the position of the mobile terminal B100. More specifically, the virtual screen may be displayed so that the virtual screen stands still at the predetermined position on the mixed reality space.

In this case, the virtual screen seems to be fixed on the mixed reality space even if the user moves. However, in generating a composite image, the size and orientation (angle and direction) of the virtual screen is changed and displayed so that the virtual screen seems to be displayed at the same position on the background image.

The display position of the virtual screen may be determined based on a predetermined position of the user. For example, the virtual screen may be displayed at the position of the user's line of sight or at a position close to the user's hand.

### Overview of Display Apparatus and Mobile Terminal Operations

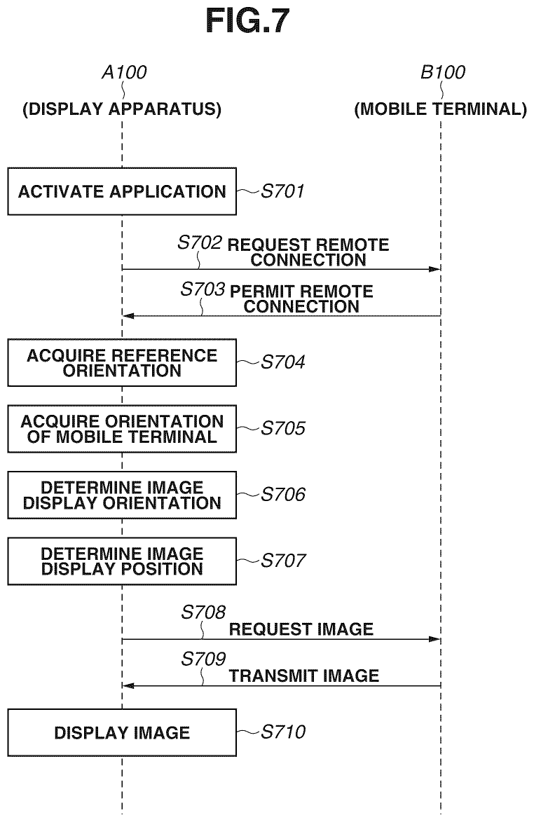

An overview of operations of the display apparatus A100 and the mobile terminal B100 according to the present exemplary embodiment will be described below with reference to FIG. 7.

FIG. 7 is a sequence diagram illustrating processing in which the display apparatus A100 and the mobile terminal B100 are connected and the screen of the mobile terminal B100 is displayed on the display apparatus A100. The following description will be provided based on the premise that the display apparatus A100 and the mobile terminal B100 have configurations similar to the display apparatus A100 and the mobile terminal B 100 illustrated in FIG. 1.

In step S701, an application activation operation is performed. Then, the display apparatus A100 performs the operations in steps S702 to S712 (described below). Examples of the application activation operation include a user operation for issuing an instruction via the input unit A104 and activation processing to be executed when the distance between the display apparatus A100 and the mobile terminal B100 falls below a predetermined distance.

In step S702, the display apparatus A100 issues requests remote connection request to the mobile terminal B100.

If the mobile terminal B100 receives a remote connection request from the display apparatus A100 in step S702, then in step S703, the mobile terminal B100 returns a remote connection permission and establishes a connection to the display apparatus A100.

In step S704, the display apparatus A100 acquires the orientation of the display apparatus A100 to be used by the display apparatus A100 to determine the image display orientation, the display orientation of the virtual screen in step S706 (described below).

In step S705, the display apparatus A100 acquires the orientation of the mobile terminal B100 to be used by the display apparatus A100 to determine the image display orientation in step S706 (described below).

In step S706, the display apparatus A100 determines the image display orientation by using the above-described method for determining the image display orientation, based on the orientation information about the display apparatus A100 acquired in step S704, the coordinate system, and the orientation information about the mobile terminal B100 acquired in step S705. The coordinate system is based on the orientation information about the display apparatus A100 acquired in step S704.

In step S707, the display apparatus A100 determines the image display position, specifically, the display position of the virtual screen by using the above-described method for determining the image display position, based on the orientation information about the mobile terminal B100 acquired in step S705.

In step S708, the display apparatus A100 requests an image corresponding to the image display orientation determined in step S706 from the mobile terminal B100. For example, the display apparatus A100 requests an image for a portrait screen of the mobile terminal B100 when the image display orientation is in the portrait state, and requests an image for a landscape screen thereof when the image display orientation is in the landscape state. Although the display apparatus A100 requests an image from the mobile terminal B100, the present exemplary embodiment is not limited thereto. The display apparatus A100 may request information for image generation. In this case, in step S709, the mobile terminal B100 transmits information to the display apparatus A100 according to the requested information. The display apparatus A100 performs information acquisition for acquiring the requested information.

In step S709, the mobile terminal B100 transmits the image requested by the display apparatus A100 in step S708 to the display apparatus A100.

In step S710, the display apparatus A100 displays the image received from the mobile terminal B100 in step S709 so that the image display orientation determined in step S706 and the image display position determined in step S707 are satisfied. Although the display apparatus A100 receives an image in a predetermined orientation from the mobile terminal B100 and displays the image as a virtual screen, the present exemplary embodiment is not limited thereto. The display apparatus A100 may receive an image in a predetermined orientation from the mobile terminal B100 and then display the image as a virtual screen so that the determined image display orientation is satisfied. For example, when the display apparatus A100 receives a portrait image from the mobile terminal B100 and displays the image as a virtual screen, a landscape virtual screen may be displayed.

The operations in steps S705 to S710 are repetitively performed until an application termination operation is performed. Examples of the application termination operation include a user operation for issuing an instruction via the input unit A104 and termination an operation to be executed when the distance between the display apparatus A100 and the mobile terminal B100 exceeds a predetermined distance.

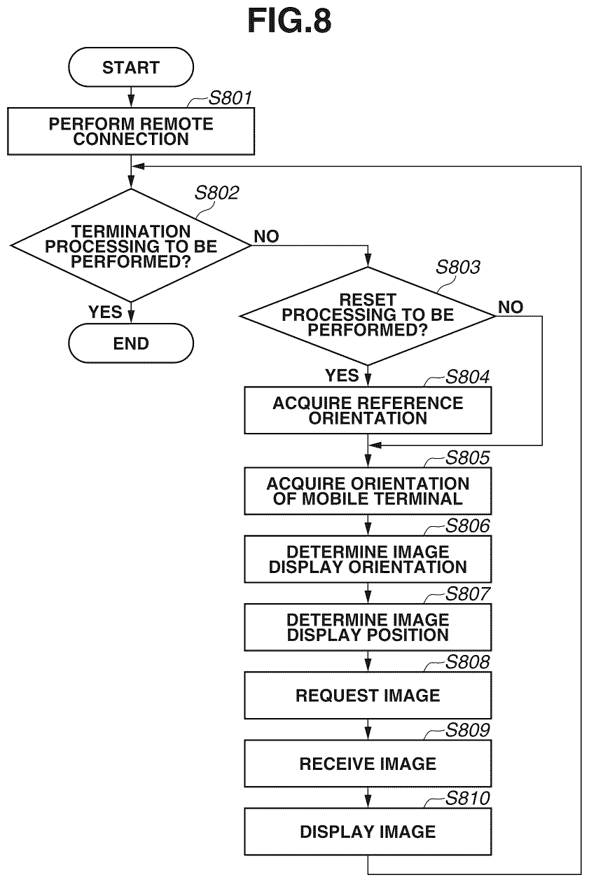

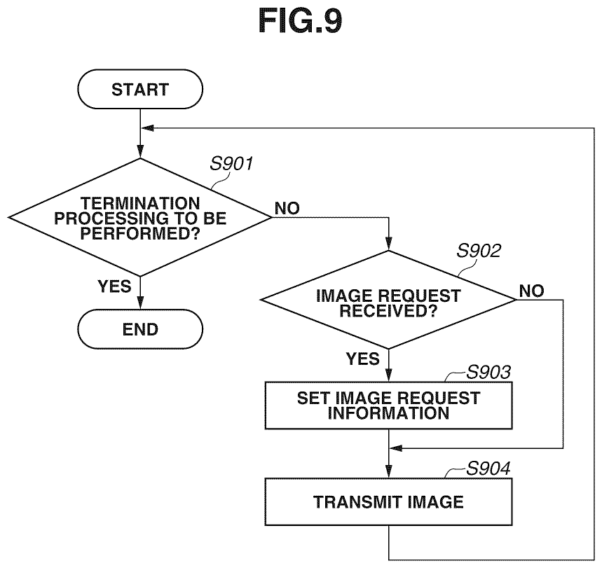

Detailed operations of the display apparatus A100 and the mobile terminal B100 for implementing the above-described sequence will be described below with reference to FIGS. 8 and 9.

FIG. 8 is a flowchart illustrating processing of the display apparatus A100 according to the present exemplary embodiment. This flowchart is started when the application activation operation is performed.

In step S801, the control unit A101 issues a remote connection request via the communication unit A107 to the mobile terminal B100. The operation in this step is equivalent to the operation in step S702 in FIG. 7.

In step S802, the control unit A101 determines whether to terminate the processing, based on the state of each unit of the display apparatus A100. For example, if a termination operation is performed via the input unit A104 or if the control unit A101 detects that the user takes off the display apparatus A100 via the sensor A106 (YES in step S802), the control unit A101 terminates the processing of this flowchart. If the control unit A101 determines to continue the processing (NO in step S802), the processing proceeds to step S803.

In step S803, the control unit A101 determines whether to perform reset processing, based on the state of each unit of the display apparatus A100. For example, the control unit A101 determines to perform the reset processing if the reset processing has not yet been performed since the application is activated or if a reset operation has been performed via the input unit A104, the control unit A101 determines to perform the reset processing. If the control unit A101 determines to perform the reset processing (YES in step S803), the processing proceeds to step S804. If the control unit A101 determines not to perform the reset processing (NO in step S803), the processing proceeds to step S805.

In step S804, the control unit A101 acquires the orientation information about the display apparatus A100 via the sensor A106. To use the acquired orientation information about the display apparatus A100 in the processing for determining the image display orientation in step S806 (described below) and/or the processing for determining the image display position in step S807, the control unit A101 stores the acquired orientation information in the memory A103. The method for acquiring the orientation information about the display apparatus A100 is as described above. The operation in this step is equivalent to the operation in step S704 in FIG. 7.

In step S805, the control unit A101 acquires the orientation information about the mobile terminal B100 via the sensor A106 or the communication unit A107. The method for acquiring the orientation information about the mobile terminal B100 from the display apparatus A100 is as described above. The operation in this step is equivalent to the operation in step S705 in FIG. 7.

In step S806, the control unit A101 determines the image display orientation based on the orientation information about the display apparatus A100 acquired in step S804 and the orientation information about the mobile terminal B100 acquired in step S805. The method for determining the image display orientation is as described above. The operation in this step is equivalent to the operation in step S706 in FIG. 7.

In step S807, the control unit A101 determines the image display position based on the orientation information about the display apparatus A100 acquired in step S804 and the orientation information about the mobile terminal B100 acquired in step S805. The method for determining the image display position is as described above. The operation in this step is equivalent to the operation in step S707 in FIG. 7.

In step S808, the control unit A101 requests an image suitable for the image display orientation determined in step S806 to the mobile terminal B100, via the communication unit A107. If there is no difference between the last requested image information and the image information to be newly requested, the control unit A101 may skip the operation in this step. The operation in this step is equivalent to the operation in step S708 in FIG. 7.

In step S809, the control unit A101 receives the image requested from the mobile terminal B100 in step S808, via the communication unit A107, and stores the image in the memory A103. The operation in this step is equivalent to the operation in step S709 in FIG. 7.

In step S810, the control unit A101 displays the image received from the mobile terminal B100 in step S809 on the output unit A105 so that the image display orientation determined in step S806 and the image display position determined in step S807 are satisfied. The operation in this step is equivalent to the operation in step S710 in FIG. 7.

FIG. 9 is a flowchart illustrating processing of the mobile terminal B100 according to the present exemplary embodiment. This flowchart is started when the mobile terminal B100 receives a connection request from the display apparatus A100.

In step S901, the control unit B101 determines whether to terminate the processing, based on the state of each unit of the mobile terminal B100. For example, if a termination operation is performed via the input unit B104 or if the control unit B101 detects that the application is terminated from the display apparatus A100, via the communication unit B107 (YES in step S901), the control unit B101 terminates the processing of this flowchart. If the control unit B101 determines to continue the processing (NO in step S901), the processing proceeds to step S902.

In step S902, the control unit B101 determines whether an image request is received from the display apparatus A100 via the communication unit B107. If the control unit B101 determines that an image request is received (YES in step S902), the processing proceeds to step S903. If the control unit B101 determines that an image request is not received (NO in step S902), the processing proceeds to step S904.

In step S903, the control unit B101 stores the image request information received in step S902 in the memory B103. The image request information refers to information to be requested by the display apparatus A100 from the mobile terminal B100 in step S708 in FIG. 7.

The operations in steps S902 and S903 are equivalent to the operation in step S708 in FIG. 7.

In step S904, the control unit B101 generates an image of the mobile terminal B100 according to the image request information stored in the memory B103 in step S903, and transmits the image to the display apparatus A100 via the communication unit B107. The operation in this step is equivalent to the operation in step S709 in FIG. 7.

As described above, the system including the display apparatus A100 and the mobile terminal B100 according to the present exemplary embodiment determines the display position and display orientation of the virtual screen to be displayed on the display apparatus A100, based on the orientation of the display apparatus A100 at a predetermined point in time and the orientation of the mobile terminal B100. The system may also determine the display orientation and display position based on the coordinate system based on the orientation of the display apparatus A100 at a predetermined point in time.

Thus, when an HMD and a mobile terminal are used in combination, the screen and position of the mobile terminal displayed on the HMD corresponds to the state of the mobile terminal, thus providing improved user experience.

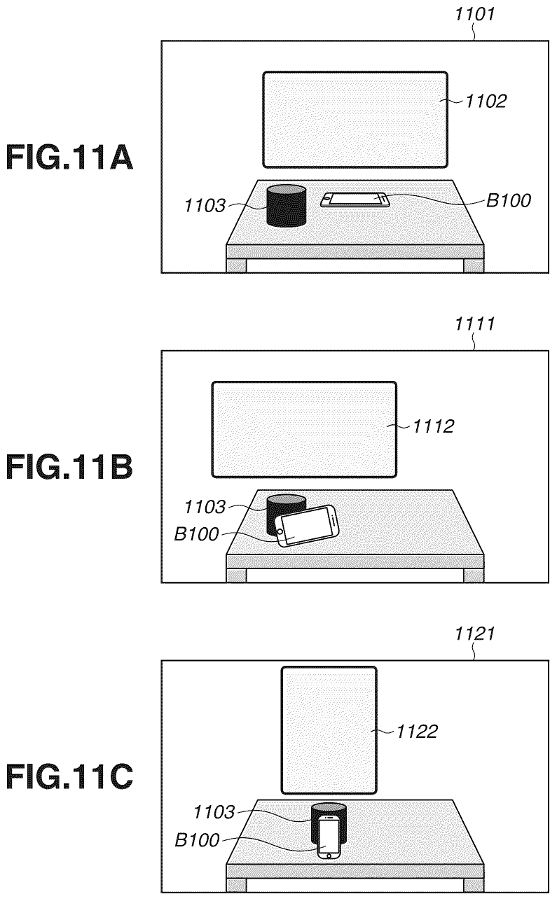

Examples of composite images which are visually recognized by the user according to the first exemplary embodiment will be described below with reference to FIGS. 11A, 11B, and 11C.

FIG. 11A assumes a scene where the mobile terminal B100 is horizontally placed to the ground in a landscape state when viewed from the user. In this case, since the mobile terminal B100 is in a landscape state when viewed from the user, the user visually recognizes a composite image 1101 generated with a virtual screen 1102 displayed in a landscape state. An object 1103 is a real object.

FIG. 11B assumes a scene where the mobile terminal B100 is laterally rested against the object 1103. In this case, since the mobile terminal B100 is in a landscape state when viewed from the user, the user visually recognizes a composite image 1111 generated with a virtual screen 1112 displayed in a landscape state.

FIG. 11C assumes a scene where the mobile terminal B100 is longitudinally rested against the object 1103. In this case, since the mobile terminal B100 is in a portrait state when viewed from the user, the user visually recognizes a composite image 1121 generated with a virtual screen 1122 displayed in a portrait state.

A second exemplary embodiment of the present disclosure will be described below. In the first exemplary embodiment, a description has been provided of a method for determining the display orientation of the image to be displayed on the display apparatus A100, based on the orientation of the display apparatus A100 at a predetermined point in time, the coordinate system based on the orientation, and the orientation of the mobile terminal B100. In the second exemplary embodiment, a description will be provided of a case of determining the display orientation of the virtual screen based on setting information about the mobile terminal B100.

For example, a smartphone may be provided with a function of locking the display screen orientation to a portrait screen. Certain content to be executed on a smartphone may lock the display screen to a portrait or landscape screen.

If the mobile terminal B100 is in such a state or if an application related to such content is being executed on the mobile terminal B100, it is desirable to determine the display orientation of the image to be displayed on the display apparatus A100 in consideration of these cases.

The present exemplary embodiment includes many portions common to the first exemplary embodiment, so that portions specific to the present exemplary embodiment will be mainly described.

A method for determining the image display orientation according to the present exemplary embodiment will be described below.

As described above, in the present exemplary embodiment, the display orientation of the image to be displayed on the display apparatus A100 is determined, in consideration of user settings of the mobile terminal B100 and screen settings such as application settings for each content.

If portrait screen display is specified in the screen settings of the mobile terminal B100, the image display orientation is determined so that the mobile terminal B100 faces front when viewed from the user in a portrait state.

If landscape screen display is specified in the screen settings of the mobile terminal B100, the image display orientation is determined so that the mobile terminal B100 faces front when viewed from the user in a landscape state.

If neither screen display is specified, the image display orientation is determined according to the method for determining the image display orientation described in the first exemplary embodiment.

While the user settings and the content-based application settings are exemplified as the screen setting information, other types of setting information may be used as the screen setting information.

The above-described method for determining the image display orientation is merely an example, and different methods for determining the image display orientation may also be applicable.

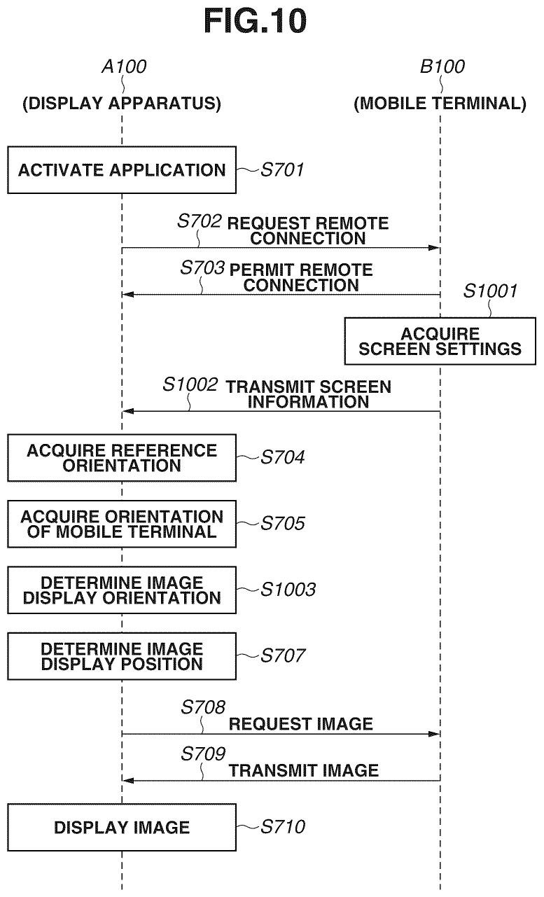

An overview of operations of the display apparatus A100 and the mobile terminal B100 according to the present exemplary embodiment will be described below with reference to FIG. 10.

FIG. 10 is a sequence diagram illustrating processing in which the display apparatus A100 and the mobile terminal B100 are connected and the screen of the mobile terminal B100 is displayed on the display apparatus A100.

Steps indicating similar operations to operations of the display apparatus A100 and the mobile terminal B100 according to the first exemplary embodiment are assigned the same reference numerals as those in FIG. 7, and redundant descriptions thereof will be omitted.

In step S1001, the mobile terminal B100 acquires the screen setting information about the mobile terminal B100 which affects the determination of the image display orientation to be made by the display apparatus A100 in step S1003 (described below). Examples of the screen setting information include whether the screen display of the mobile terminal B100 is locked to a portrait screen and whether the content display orientation of the application currently being executed on the mobile terminal B100 is fixed to a portrait or landscape state.

In step S1002, the mobile terminal B100 transmits the screen setting information acquired in step S1001 to the display apparatus A100.

The operations in steps S1001 and S1002 do not necessarily need to be performed immediately after step S703 after the establishment of connection. The operations may be performed at the timing when the screen settings of the mobile terminal B100 is updated or immediately before the display apparatus A100 determines the image display orientation. Desirably, the latest screen setting information about the mobile terminal B100 is conveyed to the display apparatus A100. Therefore, the operations in steps S1001 and S1002 may be executed each time the screen settings of the mobile terminal B100 are updated.

In step S1003, the display apparatus A100 determines the image display orientation by using the above-described method for determining the image display orientation based on the screen setting information, the orientation information about the display apparatus A100, the coordinate system based on the orientation information about the display apparatus A100, and the orientation information about the mobile terminal B100. Here, the display apparatus A100 has received the screen setting information from the mobile terminal B100 in step S1002, has acquired the orientation information about the display apparatus A100 in step S704, and has acquired the orientation information about the mobile terminal B100 in step S705.

As described above, the system including the display apparatus A100 and the mobile terminal B100 according to the present exemplary embodiment determines the display orientation of the image to be displayed on the display apparatus A100 in consideration of the screen settings of the mobile terminal B100.

While the display setting information is acquired from the mobile terminal B100 in the present exemplary embodiment, the present exemplary embodiment is not limited thereto. The system may determine which of the portrait and landscape states the screen is in based on the displayed orientation of the image captured by the display apparatus A100 on the screen of the mobile terminal B100.

Thus, in a case where an HMD and a mobile terminal are used in combination, the screen of the mobile terminal displayed on the HMD corresponds to not only the external state but also the internal state of the mobile terminal, thus providing improved user experience.

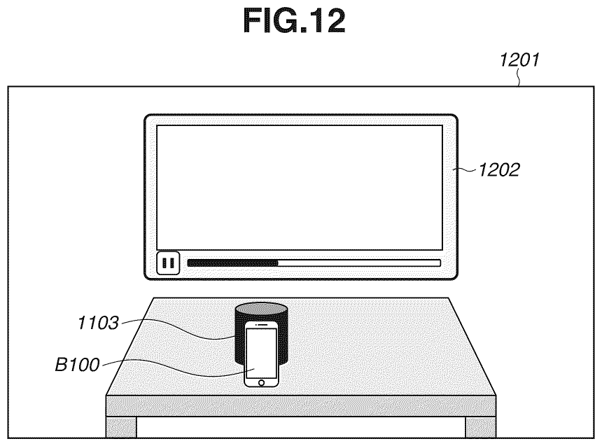

An example of a composite image which is visually recognized by the user according to the second exemplary embodiment will be described below with reference to FIG. 12.

FIG. 12 assumes a scene where the mobile terminal B100 is longitudinally rested against the object 1103. The user assumes a scene where a moving image playback content to be viewed in a landscape screen is displayed in a virtual screen 1202. In this case, since the mobile terminal B100 is in a portrait state when viewed from the user but the content is displayed in a landscape screen, the user visually recognizes a composite image 1201 generated with the virtual screen 1202 displayed in a landscape state.

A third exemplary embodiment of the present disclosure will be described below. In the first and the second exemplary embodiments, descriptions have been provided of a method for determining the display orientation and display position of the virtual screen (image) to be displayed on the display apparatus A100, based on the orientation of the display apparatus A100 at a predetermined point in time, the coordinate system based on the orientation, and the orientation of the mobile terminal B100. However, if the display orientation or display position of the virtual screen (image) is changed by a user operation, it may be desirable to display the image in accordance with the change.

Assume an example case where an image is displayed in a portrait state on the display apparatus A100 according to the method for determining the image display orientation according to the first and the second exemplary embodiments. However, if the image orientation is changed from a portrait to a landscape state by a user operation, it is desirable to keep displaying the image in a landscape state without following the method for determining the image display orientation according to the first and the second exemplary embodiments.

Similarly, if the image display position is changed by a user operation, it is desirable to keep displaying the image at the current position without following the method for determining the image display position according to the first and the second exemplary embodiments.

A third exemplary embodiment includes many portions common to the first and the second exemplary embodiments, and thus portions specific to the present exemplary embodiment will be mainly described.

A method for determining the image display orientation according to the present exemplary embodiment will be described below.

As described above, if the image display orientation is changed by a user operation, the display orientation of the image to be displayed on the display apparatus A100 is determined in consideration of the change.

A user operation that changes the screen display orientation may be performed through buttons, interfaces, and sensors of the display apparatus A100 or performed through the mobile terminal B100.

If the image display orientation is changed by a user operation, the image display orientation is determined to satisfy the orientation specified by the user.

If the image display orientation is not changed by a user operation or if the image display orientation is changed but the change is canceled, the image display orientation is determined according to the method for determining the image display orientation described in conjunction with the first or the second exemplary embodiments.

The above-described method for determining the image display orientation is merely an example, and different methods for determining the image display orientation may also be applicable.

The method for determining the image display position according to the present exemplary embodiment will be described below.

As described above, if the image display position is changed by a user operation, the display position of the image to be displayed on the display apparatus A100 is determined in consideration of the change.

A user operation that changes the screen display position may be performed through buttons, interfaces, and sensors of the display apparatus A100 or performed through the mobile terminal B100.

If the image display position is changed by a user operation, the image display position is determined so that the position specified by the user is satisfied.

If the image display position is not changed by a user operation or if the image display position is changed but the change is canceled, the image display position is determined according to the method for determining the image display position according to the first or the second exemplary embodiments.

In the present exemplary embodiment, the image display position is determined so that the position specified by the user is satisfied. Alternatively, the image display position may also be determined so that the position specified by the user on the mobile terminal B100 is recognized as a relative position.

The above-described method for determining the image display position is merely an example, and different methods for determining the image display position may also be applicable.

As described above, if the display orientation or display position is changed by a user operation, the system including the display apparatus A100 and the mobile terminal B100 according to the present exemplary embodiment determines the display orientation and display position of the image to be displayed on the display apparatus A100 in consideration of the change.

Thus, when an HMD and a mobile terminal are used in combination, the display according to the user's preferences is enabled, thus providing improved user experience.

While the present disclosure has been described based on the above-described exemplary embodiments, the present disclosure is not limited thereto but can be modified and changed in diverse ways within the scope of the appended claims.

A fourth exemplary embodiment will be described below. In the fourth exemplary embodiment, a description will be provided of a method for determining the virtual screen orientation based on information different from that according to the first and the second exemplary embodiments.

Instead of using setting information about the mobile terminal B100, the orientation of the virtual screen, specifically, either portrait or landscape, may be determined based on whether the logo or pattern on the mobile terminal B100 is in the portrait or landscape state.

Additionally, the orientation of the mobile terminal B100 may be determined based on the position of the camera of the mobile terminal B100, and the system may determine to display the virtual screen in either portrait or landscape state.

Instead of the setting information about the mobile terminal B100, the user may preset which orientations of the mobile terminal B100 correspond to the portrait and landscape states. In this case, if the orientation of the mobile terminal B100 is close to the orientation preset to be a portrait state, the virtual screen is displayed in a portrait state. If the orientation of the mobile terminal B100 is close to the orientation preset to be a landscape state, the virtual screen is displayed in a landscape state.

The present disclosure has an effect of providing an information processing apparatus with increased usability when an HMD and a mobile terminal are used in combination.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-009058, filed Jan. 24, 2024, which is hereby incorporated by reference herein in its entirety.

What is claimed is:

1. An information processing apparatus, comprising:
a processor; and
a memory storing a program which, when executed by the processor, causes the information processing apparatus to:
perform image acquisition processing for acquiring a captured image; and
perform display control processing for displaying, on a display, a composite image obtained by the captured image and a virtual screen being composited,
wherein, in the display control processing, control is performed so that in a case where a mobile terminal is in a portrait state when viewed from a user, the virtual screen is displayed in the portrait state on the display, and that in a case where the mobile terminal is in a landscape state when viewed from the user, the virtual screen is displayed in the landscape state on the display.

2. The information processing apparatus according to claim 1,
wherein the program, when executed by the processor, further causes the information processing apparatus to execute information acquisition processing for acquiring information about the virtual screen from the mobile terminal, and
wherein, in the display control processing, control is performed so that the captured image is composited with the virtual screen based on the information and the composite image is displayed on the display.

3. The information processing apparatus according to claim 2,
wherein, in the display control processing, in a case where content to be displayed on the virtual screen is content of a portrait screen, the virtual screen is displayed in the portrait state, and in a case where the content to be displayed on the virtual screen is content of a landscape screen, the virtual screen is displayed in the landscape state.

4. The information processing apparatus according to claim 3,
wherein, in the display control processing, in a case where the content to be displayed on the virtual screen is content of the portrait screen, the virtual screen is displayed in the portrait state even if the mobile terminal is in the landscape state when viewed from the user, and in a case where the content to be displayed on the virtual screen is content of the landscape screen, the virtual screen is displayed in the landscape state even if the mobile terminal is in the portrait state when viewed from the user.

5. The information processing apparatus according to claim 3,
wherein, in the information acquisition processing, in a case where the content is content of the portrait screen, information about the portrait screen is acquired from the mobile terminal, and in a case where the content is content of the landscape screen, information about the landscape screen is acquired from the mobile terminal.

6. The information processing apparatus according to claim 2, wherein, in the display control processing, in a case where an orientation of a screen of the mobile terminal is fixed, the virtual screen is displayed in the fixed orientation even if an orientation of the mobile terminal is changed.

7. The information processing apparatus according to claim 1, wherein, in the display control processing, control is performed to display, on the display, the virtual screen in the portrait or landscape state based on an orientation of the mobile terminal and an orientation of the display.

8. The information processing apparatus according to claim 7,
wherein, in the display control processing, control is performed so that in a case where the mobile terminal is horizontally placed in the portrait state when viewed from the user, the virtual screen is displayed in the portrait state on the display, and that in a case where the mobile terminal is horizontally placed in the landscape state when viewed from the user, the virtual screen is displayed in the landscape state on the display.

9. The information processing apparatus according to claim 1, wherein the program, when executed by the processor, further causes the information processing apparatus to execute determination processing for determining a front direction of the display based on an orientation of the display at a predetermined point in time,
wherein, in the display control processing, control is performed so that in a case where the mobile terminal is in the portrait state with respect to the front direction of the display at the predetermined point in time, the virtual screen is displayed in the portrait state on the display even with a change in the orientation of the display after the predetermined point in time, and that in a case where the mobile terminal is in the landscape state with respect to the front direction of the display at the predetermined point in time, the virtual screen is displayed in the landscape state on the display.

10. The information processing apparatus according to claim 9, wherein, in the determination processing, in a case where the orientation of the display is changed to an extend that exceeds a threshold value from the orientation at the predetermined point in time, control is performed to update the front direction of the display.

11. The information processing apparatus according to claim 1, wherein, in the display control processing, in a case where a distance between the mobile terminal and the user is shorter than a predetermined distance, the virtual screen is displayed.

12. The information processing apparatus according to claim 1, wherein, in the display control processing, in a case where a distance between the mobile terminal and the user exceeds a predetermined distance, display of the virtual screen is terminated.

13. The information processing apparatus according to claim 1, wherein, in the display control processing, the virtual screen is displayed so that the virtual screen follows the display according to an orientation of the display.

14. The information processing apparatus according to claim 1, wherein, in the display control processing, the virtual screen is displayed so that the virtual screen stands still in a mixed reality space even if an orientation of the display is changed.

15. A control method of an information processing apparatus, comprising:
acquiring a captured image; and
performing control to display, on a display, a composite image obtained by the captured image and a virtual screen being composited,
wherein the control is performed so that in a case where a mobile terminal is in a portrait state when viewed from a user, the virtual screen is displayed in the portrait state on the display, and that in a case where the mobile terminal is in a landscape state when viewed from the user, the virtual screen is displayed in the landscape state on the display.

16. A non-transitory computer readable medium that stores a program, wherein the program causes a computer to execute a control method according to claim 15.

17. An information processing system, comprising:
a mobile terminal;
a display apparatus;
an image acquisition apparatus configured to acquire a captured image; and
a display control apparatus configured to perform control to display, on the display apparatus, a composite image obtained by the captured image and a virtual screen being composited,
wherein the display control apparatus performs the control so that in a case where the mobile terminal is in a portrait state when viewed from a user, the virtual screen is displayed in the portrait state on the display apparatus, and that in a case where the mobile terminal is in a landscape state when viewed from the user, the virtual screen is displayed in the landscape state on the display apparatus.
